(19) United States
(12) Patent Application Publication
(10) Pub. No.: US 2024/0403907 A1
(43) Pub. Date: Dec. 5, 2024

(54) TRAINED MODEL FOR AUTOMATICALLY DETERMINING DIRECTED SPEND PROGRAM ELIGIBILITY

(71) Applicant: Maplebear Inc. (dba Instacart), San Francisco, CA (US)

(72) Inventors: Lukasz Czekaj, North Las Vegas, NV (US); Joseph Olivier, San Bruno, CA (US); Mark Ding, Seattle, WA (US); Mathieu Hartvick, Ottawa (CA); Kenny Hwu, Piedmont, CA (US); Yiheng Wang, Sunnyvale, CA (US); Domenico Matteo, San Mateo, CA (US)

(21) Appl. No.: 18/204,074

(22) Filed: May 31, 2023

(51) Int. Cl. G06Q 30/0207; G06Q 30/0601

(52) U.S. Cl. CPC G06Q 30/0222; G06Q 30/0613; G06Q 30/0641

(57) ABSTRACT

Embodiments relate to automatic determination of a directed spend program eligibility for items offered by retailers associated with an online system. The online system provides inputs into a computer model, where the inputs include information about at least one property for each candidate item in a set of candidate items and at least one requirement for a directed spend program. The online system applies the computer model to generate, based on the inputs, an output that comprises an indication of an eligibility for each candidate item in the set for the at least one directed spend program. The online system sends a message causing a device of a user of the online system to display a user interface including an option for the user to add into a cart at least one of the candidate items determined to be eligible for the directed spend program.

### BACKGROUND

Online systems, such as online concierge systems, support “directed spend” programs that allow a third party sponsor to give a stipend to customers to purchase certain items that fall within a definition of the directed spend program. It is often not practically or technically possible to manually label items for eligibility for a directed spend program, since customers shop at different stores, there are too many items to label, and the items change over time. To avoid individually labeling items, online concierge systems typically use item category information to determine eligibility for a directed spend program, where a third party sponsor of the directed spend program defines one or more rules for the directed spend program based on a hierarchical product taxonomy. However, the accuracy and specificity of labeling items in a database can vary, leading to errors in categorization of items, making such rules less reliable for defining eligibility for a directed spend program. For example, the “dairy” category may include non-dairy items such as (non-dairy) ice cream, and the online concierge systems may not be able to differentiate between different types of ice cream.

### SUMMARY

In accordance with one or more aspects of the disclosure, an online system provides a plurality of inputs into a computer model of the online system, where the plurality of inputs comprise information about at least one property for each candidate item in a set of candidate items and at least one requirement for at least one directed spend program. The online system applies the computer model to the plurality of inputs to generate an output of the computer model, the output comprising an indication of an eligibility for each candidate item in the set of candidate items for the at least one directed spend program. The online system sends a message causing a device of a user of the online system to display a user interface that indicates whether or not one or more of the candidate items are eligible for the directed spend program. The user interface further includes an option for the user to add into a cart at least one of the candidate items determined to be eligible for the directed spend program.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3A illustrates an example portion of a webpage of an online concierge system with a list of sponsored directed spend programs presented to a customer of the online concierge system, in accordance with one or more embodiments.

FIG. 3B illustrates an example portion of a webpage of an online concierge system with eligible items of a sponsored directed spend programs presented to a customer of the online concierge system, in accordance with one or more embodiments.

FIG. 4 is a flowchart of a method of automatically determining a directed spend program eligibility at an online concierge system, in accordance with one or more embodiments.

### DETAILED DESCRIPTION

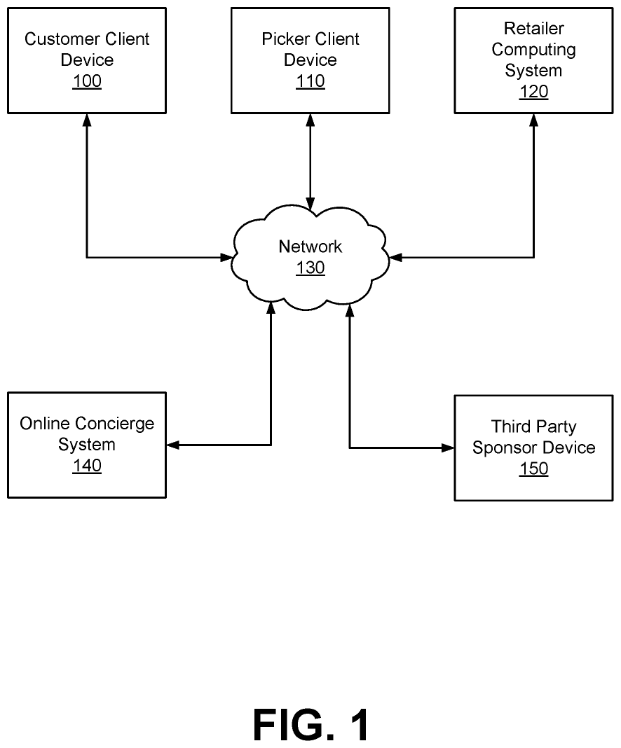

FIG. 1 illustrates an example system environment for an online concierge system 140, in accordance with one or more embodiments. The system environment illustrated in FIG. 1 includes a customer client device 100, a picker client device 110, a retailer computing system 120, a network 130, an online concierge system 140, and a third party sponsor device 150. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item”, as used herein, means a good or product that can be provided to the customer through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer, so that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provide portions of the payment from the customer to the picker and the retailer.

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140.

In accordance with one or more embodiments of the present disclosure, the online concierge system 140 offers to customers a directed spend program with a set of eligible items for inclusion into a shopping cart. A third party sponsor defines the directed spend program in which the third party sponsor offers a stipend to customers to pay for the set of eligible items. An example of third party sponsor is a health care provider sponsoring directed spend programs of, e.g., “healthy products”, “products for expecting moms” “products for new parents”, etc. The third party sponsor defines a set of rules (i.e., one or more requirements) for items to be eligible for a particular directed spend program. The third party sponsor device 150 that belongs to the third party sponsor sends to the online concierge system 140 (e.g., via the network 130) information about the set of rules (i.e., one or more requirements) for items to be eligible for the directed spend program. Although FIG. 1 illustrates the online concierge system 140 interfaced with a single third party sponsor device 150, it should be understood that the online concierge system 140 can be interfaced with multiple third party sponsor devices 150 each belonging to a respective third party sponsor that offers at least one directed spend program to the online concierge system 140.

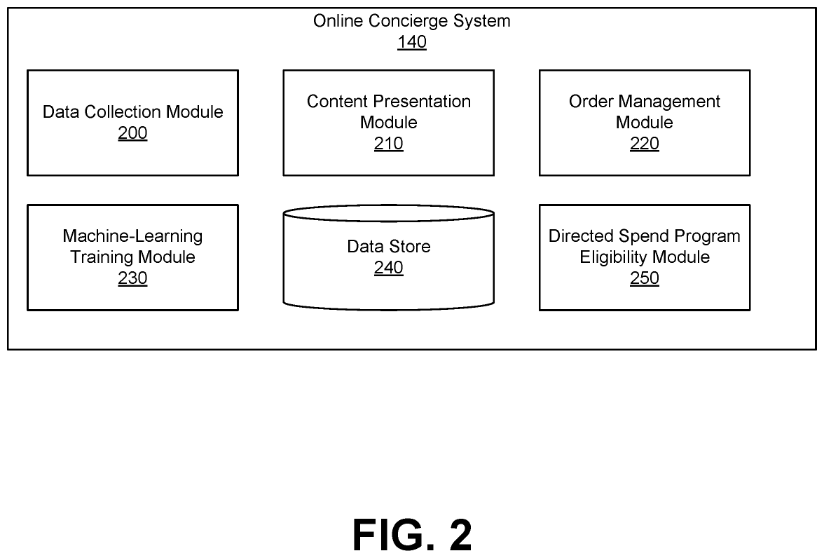

One or more retailers associated with the online concierge system 140 can offer their items as candidate items for one or more directed spend programs. The online concierge system 140 applies a set of eligibility rules for a directed spend program received from the third party sponsor device 150 to each candidate item offered by the one or more retailers in order to determine whether that candidate item meets the eligibility rules for the directed spend program. To scale this determination, the online concierge system 140 trains a computer model to determine eligibility of various items from multiple retailers for one or more directed spend programs. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine-learning training module 230, a data store 240, and a directed spend program eligibility module 250. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits an ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine-learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine-learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of the order. In some embodiments, the order management module 220 computes an estimated time of arrival of the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include customer data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The directed spend program eligibility module 250 determines an eligibility for each candidate item in a set of candidate items for at least one directed spend program. The directed spend program eligibility module 250 may apply a computer model trained to determine the eligibility for each candidate item for the at least one directed spend program. The computer model deployed by the directed spend program eligibility module 250 may run a machine-learning algorithm to determine the directed spend program eligibility for each candidate item. A set of parameters for the computer model may be stored on one or more non-transitory computer-readable media of the directed spend program eligibility module 250. Alternatively, the set of parameters for the computer model may be stored on one or more non-transitory computer-readable media of the data store 240.

The directed spend program eligibility module 250 may provide a plurality of inputs into the computer model. The plurality of inputs may include information about at least one property (i.e., product information) of each candidate item in the set of candidate items and at least one requirement for a directed spend program. The information about the property for each candidate item may be available in a database as part of, e.g., the data store 240. The requirements for the directed spend program define eligibility of items for directed spend program. The requirements for the directed spend program may be received at the directed spend program eligibility module 250 from at least one third party sponsor (e.g., via the third party sponsor device 150).

The directed spend program eligibility module 250 applies the computer model to the plurality of inputs to generate an output of the computer model. The output of the computer model includes an indication of an eligibility for each candidate item in the set of candidate items for the at least one directed spend program. In one or more embodiments, the directed spend program eligibility module 250 generates (e.g., via the computer model) the output with an indication of an eligibility for each candidate item for one directed spend program at a time. In another embodiment, the directed spend program eligibility module 250 generates (e.g., via the computer model) the output with an indication of an eligibility for each candidate item for multiple directed spend programs simultaneously.

In one or more embodiments, the computer model deployed by the directed spend program eligibility module 250 is a machine-learning model that uses various product information (i.e., properties of candidate items) to determine eligibility of candidate items for one or more directed spend programs. The computer model may apply a decision tree based algorithm onto the plurality of inputs to generate the output with the indication of eligibility for each candidate item for the one or more directed spend programs. Alternatively or additionally, the computer model may apply a random forest based algorithm onto the plurality of inputs to generate the output with the indication of eligibility for each candidate item for the one or more directed spend programs. Alternatively or additionally, the computer model may apply a neural network based algorithm onto the plurality of inputs to generate the output with the indication of eligibility for each candidate item for the one or more directed spend programs. The computer model deployed by the directed spend program eligibility module 250 may apply a corresponding algorithm depending on the complexity of inputs provided to the computer model and at least one requirement for at least one directed spend program.

The at least one property for each candidate item provided to the computer model deployed by the directed spend program eligibility module 250 includes information about at least one of a category of each candidate item and a name of each candidate item available at the data store 240. The inputs to the computer model may further include information about a purchase history for each candidate item. Alternatively or additionally, the inputs to the computer model may include information about at least one property of users (i.e., customers) of the online concierge system 140, such as customer demographics and/or a purchase history for each customer.

The directed spend program eligibility module 250 receives the at least one requirement for the at least one directed spend program for each candidate item in the set of candidate items from at least one third party sponsor (e.g., via the third party sponsor device 150). In one or more embodiments, the set of candidate items comprises a plurality of items (e.g., all items) associated with a plurality of retailers, such as all items in all stores associated with all retailers that communicate with the online concierge system 140. In another embodiment, the directed spend program eligibility module 250 filters a plurality of items associated with a plurality of retailers to obtain the set of candidate items that fit a specific coarse definition. The filtering performed at the directed spend program eligibility module 250 saves computational resources when deploying the computer model to determine eligibility of each candidate item from the set of candidate items for the at least one directed spend program, as the set of candidate items is substantially reduced in comparison with the set of all items in all stores.

The machine-learning training module 230 trains the computer model deployed by the directed spend program eligibility module 250 using a labeled dataset of items and information about a directed spend program eligibility status for each item in the labeled dataset. The labeled dataset may be available at the data store 240. During training, the computer model learns to associate the item information with the eligibility status in relation to one or more directed spend programs. Furthermore, during training, the computer model develops a set of rules to determine eligibility of new items for the one or more directed spend programs.

The machine-learning training module 230 may retrain (or, more generally, “update”) the computer model periodically to maintain accuracy of the computer model. The computer model can be retrained as new product information becomes available or as at least one requirement for at least one directed spend program changes. The machine-learning training module 230 may retrain the computer model based on information about at least one property of one or more new candidate items that are available at, e.g., the data store 240. Alternatively or additionally, the machine-learning training module 230 may retrain the computer model based on information about a change in at least one requirement for at least one directed spend program. The computer model may be also retrained when a requirement for a new directed spend program is received from a third party sponsor (e.g., via the third party sponsor device 150). The retraining allows the computer model to continuously adapt and maintain its accuracy, thus ensuring that the computer model remains effective and relevant over time.

The output of the computer model deployed by the directed spend program eligibility module 250 includes an indication whether a given item is eligible for the at least one directed spend program. The output of the computer model may thus represent a prediction of the eligibility of items for different directed spend programs. In one or more embodiments, the indication of the eligibility for each candidate item represents a binary indication of eligibility for each candidate item for the at least one directed spend program. In another embodiment, the indication of the eligibility for each candidate item represents a probability score indicating a likelihood of eligibility for each candidate item for the at least one directed spend program. The directed spend program eligibility module 250 automatically approves or rejects each candidate item for the at least one directed spend program based on the indication of the eligibility for each candidate item that is output by the computer model. In one or more embodiments, when a confidence form model for a particular directed spend program is below a defined threshold, the online concierge system 140 allows for manual review of an eligibility of each candidate item for the particular directed spend program.

The content presentation module 210 presents to a customer one or more items that are approved for a particular directed spend program by the directed spend program eligibility module 250. The online concierge system 140 places the customer in a directed spend program, e.g., by placing information about the customer in at least one specific register of the online concierge system 140 dedicated to the directed spend program. The customer browses a particular store and may search for items that are in the directed spend program. Other customers of the online concierge system 140 may use this technique for defining sponsored products for an ad campaign. By employing the presented approach for determining eligibility of items for a specific directed spend program, the online concierge system 140 may define “healthy” or other types of foods for presentation to the customer.

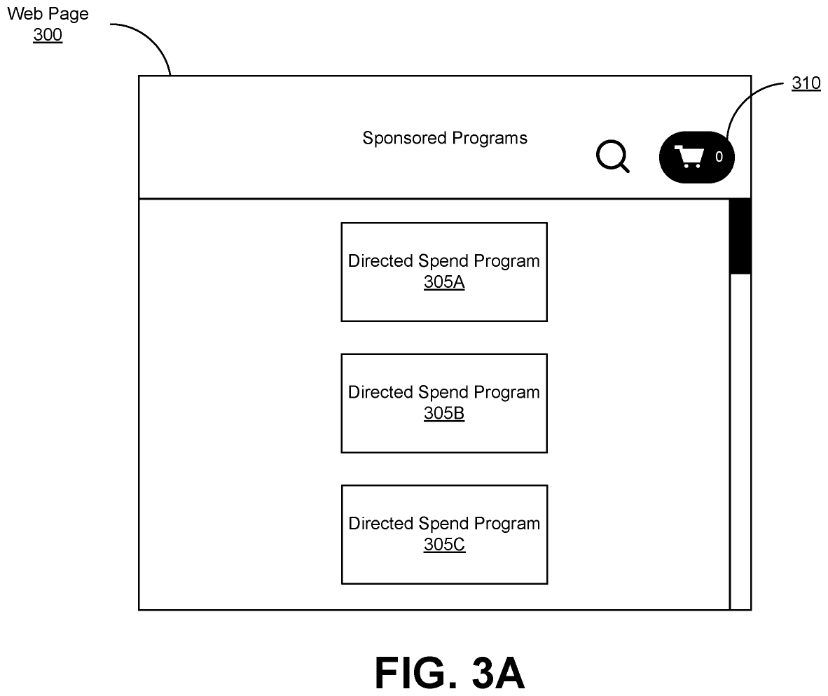

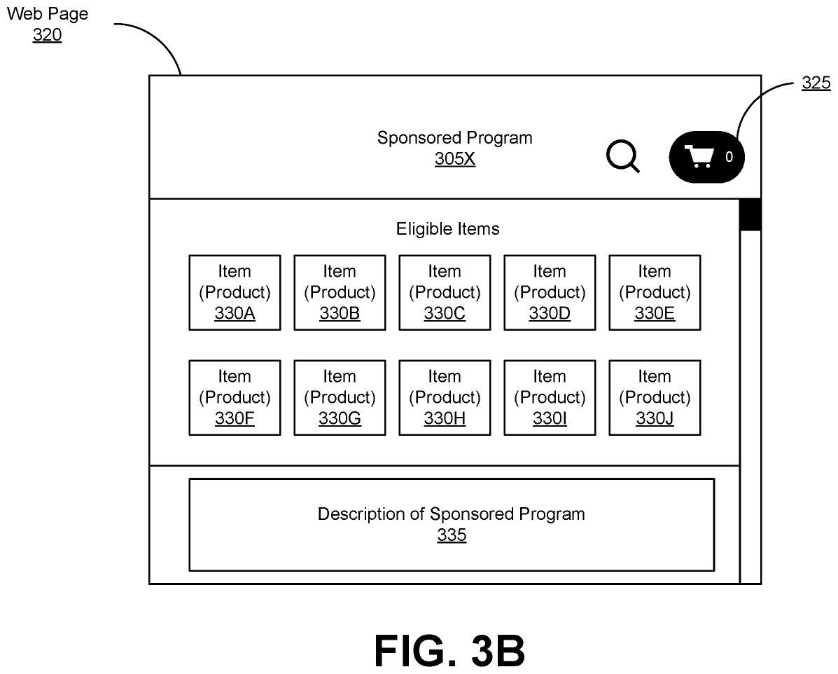

FIG. 3A illustrates an example portion of a webpage 300 of the online concierge system 140 with a list of sponsored directed spend programs presented to a customer of the online concierge system 140, in accordance with one or more embodiments. The web page 300 can be an application web page of the online concierge system 140. Alternatively, the web page 300 can be a web page of the online concierge system 140 on an Internet browser. The web page 300 can include fewer or more directed spend programs than what is shown in FIG. 3A. The online concierge system 140 presents (e.g., via the content presentation module 210) the web page 300 with icons of directed spend programs 305A-305C to the customer. The directed spend programs 305A-305C may be sponsored by one or more third party sponsors. Each icon of the directed spend programs 305A-305C may include a corresponding short title and/or description associated with that particular directed spend program that is provided by a third party sponsor (e.g., via the third party sponsor device 150). The customer can select any of the presented directed spend programs 305A-305C for a more detailed view and possible inclusion of items of the selected directed spend programs 305A-305C into a shopping cart 310.

FIG. 3B illustrates an example portion of a webpage 320 of the online concierge system with items of a sponsored directed spend program presented to a customer of the online concierge system 140, in accordance with one or more embodiments. When the customer selects for viewing any of the presented directed spend programs 305A-305C, the web page 300 changes into the web page 320 with an expanded view of the selected directed spend programs 305A-305C. The online concierge system 140 generates the web page 320 that presents (e.g., via the content presentation module 210) a sponsored directed spend program 305X (e.g., any of the directed spend programs 305A-305C that is selected for viewing) and eligible items (products) 330A-330J that are part of the directed spend program 305X. The directed spend program 305X presented via the web page 320 may include fewer or more eligible items than what is shown in FIG. 3B. Each eligible item (product) 330A-330J may include a name and a picture associated with that item 330A-330J. The web page 320 may further include one or more additional details of the directed spend program 305X, such as a description 335 of the directed spend program 305X. The description 335 may be received at the online concierge system 140 from a third party sponsor (e.g., via the third party sponsor devices 150) and may be presented to the customer via the content presentation module 210.

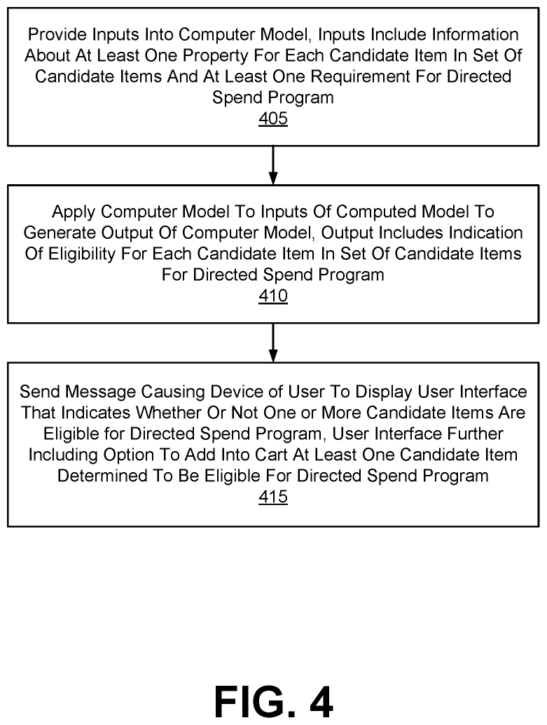

FIG. 4 is a flowchart of a method of automatically determining a directed spend program eligibility, in accordance with one or more embodiments. Alternative embodiments may include more, fewer, or different steps from those illustrated in FIG. 4, and the steps may be performed in a different order from that illustrated in FIG. 4. These steps may be performed by an online concierge system (e.g., the online concierge system 140). Additionally, each of these steps may be performed automatically by the online concierge system without human intervention.

The online concierge system 140 provides 405 a plurality of inputs into a computer model of the online concierge system 140 (e.g., the computer model deployed by the directed spend program eligibility module 250), the plurality of inputs comprising information about at least one property for each candidate item in a set of candidate items and at least one requirement for at least one directed spend program. The online concierge system 140 applies 410 the computer model to the plurality of inputs to generate an output of the computer model, the output comprising an indication of an eligibility for each candidate item in the set of candidate items for the at least one directed spend program. The online concierge system 140 sends 415 a message (e.g., from the directed spend program eligibility module 250 to the content presentation module 210) causing a device of a user of the online system (e.g., the customer client device 100) to display a user interface that indicates whether or not one or more of the candidate items are eligible for the directed spend program, wherein the user interface further includes an option for the user to add into a cart at least one of the candidate items determined to be eligible for the directed spend program.

Embodiments of the present disclosure are directed to a method and an online system for automatic determination of a directed spend program eligibility using enhanced item categorization. To improve the accuracy and specificity of the item categorization, the online system utilizes a trained computer model (e.g., machine learning model) to categorize the items. The computer model is trained to determine eligibility for an item in at least one directed spend program. To improve the accuracy and specificity of the item categorization, outputs of the computer model are incorporated into an automatic decision on whether a particular item is eligible for a specific directed spend program. Based on an output of the computer model, certain items may be automatically approved or rejected for different directed spend programs. This helps to streamline the approval process and reduce the workload for human decision-makers, while ensuring that only eligible items are approved. Furthermore, the online system presented herein is able to better distinguish between items and meet specific needs of third parties that sponsor different directed spend programs. For example, if a third party sponsor wishes to create a directed spend program that includes a chocolate ice cream but excludes a vanilla ice cream, the computer model presented herein can identify and apply those distinctions accurately.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

1. A method comprising, at a computer system comprising a processor and a computer-readable medium:
training a set of parameters of a machine-learning model of an online system using a dataset of items and information about a directed spend program eligibility status for each item in the dataset so that the machine-learning model is trained to associate information about each item in the dataset with the directed spend program eligibility status and to develop a set of rules for determining an eligibility of one or more new items for a plurality of directed spend programs;
obtaining a plurality of inputs for the machine-learning model, the plurality of inputs comprising information about at least one property for each candidate item in a set of candidate items and a plurality of requirements for the plurality of directed spend programs;
applying the machine-learning model to generate, based on the plurality of inputs, an indication of an eligibility for each candidate item in the set of candidate items for each of the plurality of directed spend programs;
responsive to the indication of the eligibility generated by the machine-learning model for one or more items from the set of candidate items for a directed spend program of the plurality of directed spend programs, associating the one or more items with the directed spend program;
responsive to associating the one or more items with the directed spend program, generating an icon for displaying at a user interface of a device associated with a user of the online system, the icon including information about the directed spend program and a functionality for displaying a detailed view of each of the one or more items;
responsive to generating the icon, generating the user interface that displays the icon;
responsive to an engagement by the user with the icon, generating an updated version of the user interface that displays the detailed view of each of the one or more items with an option for the user to order each of the one or more items; and
re-training the machine-learning model by updating, responsive to and based on information about one or more new candidate items and a change in one or more requirements of the plurality of requirements for one or more directed spend programs of the plurality of directed spend programs, the set of parameters of the machine-learning model.

2. The method of claim 1, wherein the at least one property for each candidate item comprises information about at least one of a category of each candidate item and a name of each candidate item available at a data store of the online system.

3. The method of claim 1, wherein the plurality of inputs further comprise information about at least one of a purchase history for each candidate item and one or more properties of a plurality of users of the online system that purchased each candidate item.

4. The method of claim 1, further comprising:
receiving the plurality of requirements for the plurality of directed spend programs for each candidate item in the set of candidate items from at least one third party sponsor.

5. The method of claim 1, wherein the set of candidate items comprises a plurality of items associated with a plurality of retailers.

6. The method of claim 1, further comprising:
filtering a plurality of items associated with a plurality of retailers to obtain the set of candidate items.

7-9. (canceled)

10. The method of claim 1, wherein the indication of the eligibility for each candidate item comprises a binary indication of eligibility for each candidate item for each of the plurality of directed spend programs.

11. The method of claim 1, wherein the indication of the eligibility for each candidate item comprises a probability score indicating a likelihood of eligibility for each candidate item for each of the plurality of directed spend programs.

12. The method of claim 1, further comprising:
automatically approving or rejecting each candidate item for each of the plurality of directed spend programs based on the indication of the eligibility.

13. The method of claim 1, wherein the machine-learning model comprises at least one of a decision tree based model, a random forest based model, and a neural network based model.

14. A computer program product comprising a non-transitory computer readable storage medium having instructions encoded thereon that, when executed by a processor, cause the processor to perform steps comprising:
training a set of parameters of a machine-learning model of an online system using a dataset of items and information about a directed spend program eligibility status for each item in the dataset so that the machine-learning model is trained to associate information about each item in the dataset with the directed spend program eligibility status and to develop a set of rules for determining an eligibility of one or more new items for a plurality of directed spend programs;
obtaining a plurality of inputs for the machine-learning model, the plurality of inputs comprising information about at least one property for each candidate item in a set of candidate items and a plurality of requirements for the plurality of directed spend programs;
applying the machine-learning model to generate, based on the plurality of inputs, an indication of an eligibility for each candidate item in the set of candidate items for each of the plurality of directed spend programs;
responsive to the indication of the eligibility generated by the machine-learning model for one or more items from the set of candidate items for a directed spend program of the plurality of directed spend programs, associating the one or more items with the directed spend program;
responsive to associating the one or more items with the directed spend program, generating an icon for displaying at a user interface of a device associated with a user of the online system, the icon including information about the directed spend program and a functionality for displaying a detailed view of each of the one or more items;
responsive to generating the icon, generating the user interface that displays the icon;
responsive to an engagement by the user with the icon, generating an updated version of the user interface that displays the detailed view of each of the one or more items with an option for the user to order each of the one or more items; and
re-training the machine-learning model by updating, responsive to and based on information about one or more new candidate items and a change in one or more requirements of the plurality of requirements for one or more directed spend programs of the plurality of directed spend programs, the set of parameters of the machine-learning model.

15. The computer program product of claim 14, wherein:
the at least one property for each candidate item comprises information about at least one of a category of each candidate item and a name of each candidate item available at a data store of the online system; and
the plurality of inputs further comprise information about at least one of a purchase history for each candidate item and one or more properties of a plurality of users of the online system that purchased each candidate item.

16. The computer program product of claim 14, wherein the instructions further cause the processor to perform steps comprising:
filtering a plurality of items associated with a plurality of retailers to obtain the set of candidate items.

17-18. (canceled)

19. The computer program product of claim 14, wherein the instructions further cause the processor to perform steps comprising:
automatically approving or rejecting each candidate item for each of the plurality of directed spend programs based on the indication of the eligibility.

20. A computer system comprising:
a processor; and
a non-transitory computer-readable storage medium having instructions that, when executed by the processor, cause the computer system to perform steps comprising:
training a set of parameters of a machine-learning model of an online system using a dataset of items and information about a directed spend program eligibility status for each item in the dataset so that the machine-learning model is trained to associate information about each item in the dataset with the directed spend program eligibility status and to develop a set of rules for determining an eligibility of one or more new items for a plurality of directed spend programs;
obtaining a plurality of inputs for the machine-learning model, the plurality of inputs comprising information about at least one property for each candidate item in a set of candidate items and a plurality of requirements for the plurality of directed spend programs;
applying the machine-learning model to generate, based on the plurality of inputs, an indication of an eligibility for each candidate item in the set of candidate items for each of the plurality of directed spend programs;
responsive to the indication of the eligibility generated by the machine-learning model for one or more items from the set of candidate items for a directed spend program of the plurality of directed spend programs, associating the one or more items with the directed spend program;
responsive to associating the one or more items with the directed spend program, generating an icon for displaying at a user interface of a device associated with a user of the online system, the icon including information about the directed spend program and a functionality for displaying a detailed view of each of the one or more items;
responsive to generating the icon, generating the user interface that displays the icon;
responsive to an engagement by the user with the icon, generating an updated version of the user interface that displays the detailed view of each of the one or more items with an option for the user to order each of the one or more items; and
re-training the machine-learning model by updating, responsive to and based on information about one or more new candidate items and a change in one or more requirements of the plurality of requirements for one or more directed spend programs of the plurality of directed spend programs, the set of parameters of the machine-learning model.
